(19) United States
(12) Patent Application Publication
(10) Pub. No.: US 2007/0111742 A1
(43) Pub. Date: May 17, 2007

(54) Method and apparatus to increasing system capacity in p2p enabled systems

(75) Inventors: Xuejun Zhang, Shanghai (CN); Li Sun, Shanghai (CN)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., Eindhoven (NL)

(21) Appl. No.: 10/580,629

(22) PCT Filed: Nov. 19, 2004
(86) PCT No.: PCT/IB04/52485

§ 371 Date: May 24, 2006

(30) Foreign Application Priority Data
Nov. 28, 2003 (CN) 200310115792.9

(51) Int. Cl. H04B 1/38; H04B 7/00

(52) U.S. Cl. 455/517; 455/90.2

(57) ABSTRACT

A method for a network system to increase system capacity of P2P communication, performed by a network system, comprises: detecting the position of active P2P UEs in P2P communication mode (S30) and the position of two UEs trying to establish P2P communication; judging whether any of the two UEs falls into the radio range of any active UE (S40) except the two UEs, according to the detected position information; allocating relevant radio resource to the two Ues (S80) so that the two UEs can perform P2P communication, according to the judgment result.

### FIELD OF THE INVENTION

The present invention relates generally to a communication method and apparatus in TDD CDMA communication systems, and more particularly, to a method and apparatus for increasing system capacity in P2P-enabled communication systems.

### BACKGROUND OF THE INVENTION

In conventional cellular mobile communication systems, a UE (user equipment) has to communicate with the other UE only through the relaying of base stations regardless of the distance between the two UEs. FIG. 1 illustrates this conventional communication mode, where UE1 and UE2 exchange information through the UTRAN consisting of the base station transceiver (namely Node B) and the RNC, and this communication mode is also called UP-UTRAN-DOWN mode. However, in some cases when the distance between two UEs in the same cell is very close, it can be a more reasonable way for them to communicate directly, rather than through the relaying of base stations. This method is the so-called peer-to-peer communication, abbr. as P2P.

FIG. 2 illustrates a P2P communication mode. As shown in FIG. 2, where the dashed line represents signaling link, the solid line represents data link and the arrowhead represents direction of information flow. Only signaling link exists between the UTRAN and the UE, while only data link exists between the two communicating UEs. Assume that only resource for maintaining basic communication is needed. If a direct link is taken as one unit of radio resource (with fixed frequency, timeslot and spreading code), it can be easily drawn that P2P communication mode only needs two units of radio resource to maintain basic communication. If additional signaling cost for management is ignored, P2P communication can save about 50% radio resource than conventional communication mode. Meanwhile, the UTRAN still holds control over P2P communication, especially over how to use radio resources, so network operators can easily charge for the radio resource used in P2P communication.

It is commonly accepted that a Time Division Duplex (TDD) air interface is a communication standard that offers a more flexible adaptation to different uplink and downlink traffic requirements. Among existing 3G systems based on TDD communication scheme, TD-SCDMA (Time Division-Synchronization Code Division Multiple Access) system is the most suitable system for the combination of P2P communication with conventional communication mode, because the same carrier frequency is applied in both uplink and downlink communications, which can simplify the RF (Radio Frequency) module of the mobile terminal.

A method and apparatus for establishing P2P communication in wireless communication networks, as described in the patent application entitled “A Method and Apparatus for Establishing P2P Communication in Wireless Communication Networks”, filed by KONINKLIJKE PHILIPS ELECTRONICS N.V. on Mar. 7, 2003, with the application Serial NO. as 03119892.9, is suitable to any TDD CDMA communication system including TD-SCDMA systems, and incorporated herein as reference.

A method and apparatus for radio link establishment and maintenance with P2P communication in wireless communication networks, as described in the patent application entitled “A Method and Apparatus for Radio Link Establishment and Maintenance with P2P Communication in Wireless Communication Networks”, filed by KONINKLIJKE PHILIPS ELECTRONICS N.V. on Mar. 7, 2003, with the application Serial NO. as 03119895.3, is suitable to any wireless communication system including TD-SCDMA systems, and incorporated herein by reference.

After establishing uplink synchronization with the UTRAN through the same random access procedure as existing TD-SCDMA systems, the UE can establish a P2P direct link with the other UE, using the method and apparatus as described in the patent application document whose application Serial NO. is 03119892.9, i.e.: allocate corresponding dedicated resource for two P2P UEs. Then, a direct link between the two UEs can be established and maintained in accordance with the method and apparatus as described in the patent application document whose application Serial NO. is 03119895.3, so that the two UEs can receive and transmit P2P signals in the allocated timeslots respectively, and thus P2P communication between two UEs can be achieved.

However, the introduction of P2P communication changes the conventional UP-UTRAN-DOWN communication mode in TD-SCDMA communication systems. When conventional link shares the same timeslot with P2P link, conventional uplink and/or downlink communications will unavoidably produce interference with the communication in P2P link, which is likely to deteriorate the performance of P2P-enabled TDD CDMA communication systems seriously.

FIG. 3 shows the various possible interferences caused by introducing P2P in TD-SCDMA communication systems. Signal S2 sent from UE A to UE B shares the same uplink timeslot with signal S1 sent from UE C to base station B, so UE B can receive P2P signals from UE A as well as radio signals from UE C when UE B receives the signals in the uplink timeslot, if it falls within the radio range of UE C, and at this time, signal S1 sent by UE C becomes interfering signal I1 for UE B, and signal S2 sent by UE A becomes interfering signal I2 for the base station. Similarly, if UE C falls within the P2P radio range of UE B, when signal S4 sent from UE B to UE A shares the same downlink timeslot with signal S3 sent from base station B to UE C, signal S4 becomes interfering signal I4 for UE C while signal S3 becomes interfering signal I3 for UE A. Moreover, when radio interference is produced between P2P communicating pair UE A-B and P2P communicating pair UE D-E by sharing the same timeslots, there are interfering signals 15 and 16.

As for the above interfering signal I2, detailed descriptions are respectively given to two methods and apparatuses for mitigating interfering signal I2, as proposed in the patent application entitled “A Method and Apparatus for Maintaining Uplink Synchronization with P2P Communication in Wireless Communication Networks”, filed by KONINKLIJKE PHILIPS ELECTRONICS N.V. on Mar. 7, 2003, with the application Serial NO. as 03119894.5, and in another patent application entitled “A Method and Apparatus for Maintaining Uplink Synchronization with P2P Communication in Wireless Communication Networks”, filed by KONINKLIJKE PHILIPS ELECTRONICS N.V. on May 19, 2003, with the application Serial NO. as 03123738.X, and incorporated herein by reference.

A method and apparatus is proposed for canceling interfering signal I3, as described in another patent application entitled “A Method and Apparatus for Supporting P2P Communication in TDD CDMA Communication Systems”, filed by KONINKLIJKE PHILIPS ELECTRONICS N.V. on Apr. 11, 2003, with the application Serial NO. as 03110415.0, and incorporated herein by reference.

As for the above interfering signals I1, I4, I5 and I6, two methods and apparatuses are proposed for mitigating interfering signals I1, I4, I5 and I6, as described in patent application entitled “A Method and Apparatus for Supporting P2P Communication in TDD CDMA Communication Systems”, filed by KONINKLIJKE PHILIPS ELECTRONICS N.V. on May 19, 2003, with the application Serial NO. as 03123740.1, and in another patent entitled “A Method and Apparatus for Mitigating P2P Interferences in P2P-enabled Communication Systems”, filed by KONINKLIJKE PHILIPS ELECTRONICS N.V. on Nov. 10, 2003, with the archive Serial NO. as CN030051 and application Serial NO. as 200310115658.9, and incorporated herein by reference.

The above interfering signal I1, I4, I5 and I6 can be classified into two types: interferences caused between conventional UEs and P2P UEs, such as I1 and I4; interferences caused between two pairs of P2P UEs, such as I5 and I6.

In CDMA systems, spreading techniques are well known to be able to improve system performance. But to a cell, the number of orthogonal channel codes to be used for spreading techniques is limited, thus the system capacity is very associated with the available orthogonal channel codes.

### SUMMARY OF THE INVENTION

An object of the present invention is to provide a method and apparatus for increasing system capacity in P2P-enabled communication systems, capable of increasing system capacity, as well as avoiding interference between pairs of P2P communicating UEs.

A method is proposed in the present invention for increasing P2P communication system capacity, performed by a network system, comprising: (a) detecting the position of active P2P communicating UEs and the position of two UEs trying to establish P2P communication; (b) judging whether any of the two UEs falls into the radio range of any active UE, according to the detected position information; (c) allocating corresponding radio resource to the two UEs for them to enable P2P communication, according to the judgment result.

### BRIEF DESCRIPTION OF THE DRAWINGS

For a detailed description of the preferred embodiments of the invention, reference will now be made to the accompanying drawings in which:

FIG. 1 is a schematic diagram illustrating two UEs communicate through the relaying of base stations in conventional communication mode;

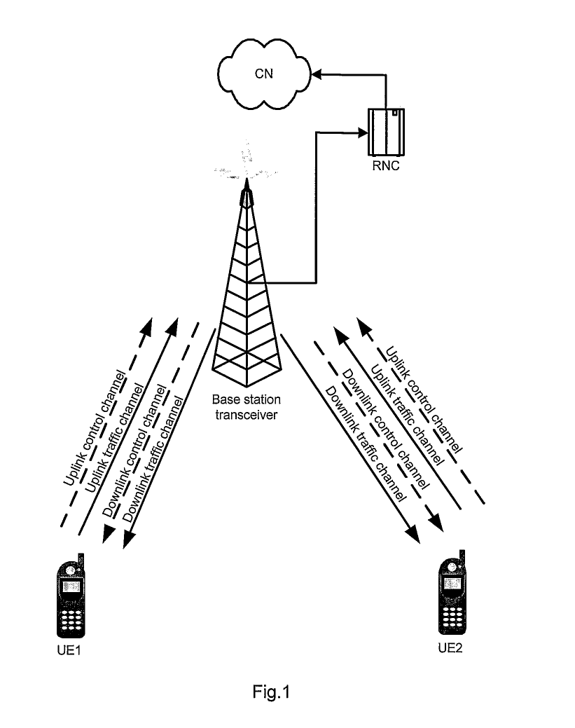

FIG. 2 is a schematic diagram illustrating two UEs communicate in P2P communication mode;

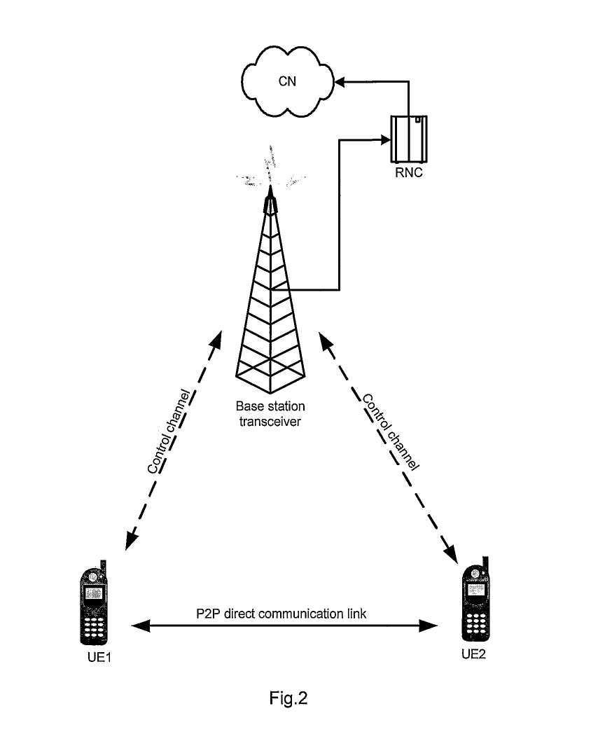

FIG. 3 is a schematic diagram illustrating various interfering signals caused by introducing P2P communication mode in TD-SCDMA systems;

FIG. 4 is a schematic diagram illustrating that several pairs of UEs are classified into several pseudo-cells in a common serving cell;

FIG. 5 is a schematic diagram illustrating how the method for increasing system capacity by reusing channel codes in the present invention is executed by UE1, UE2 and the UTRAN;

FIG. 6 is a block diagram illustrating an embodiment of the present invention for increasing system capacity in P2P-enabled TD-SCDMA systems.

### DETAILED DESCRIPTION OF THE INVENTION

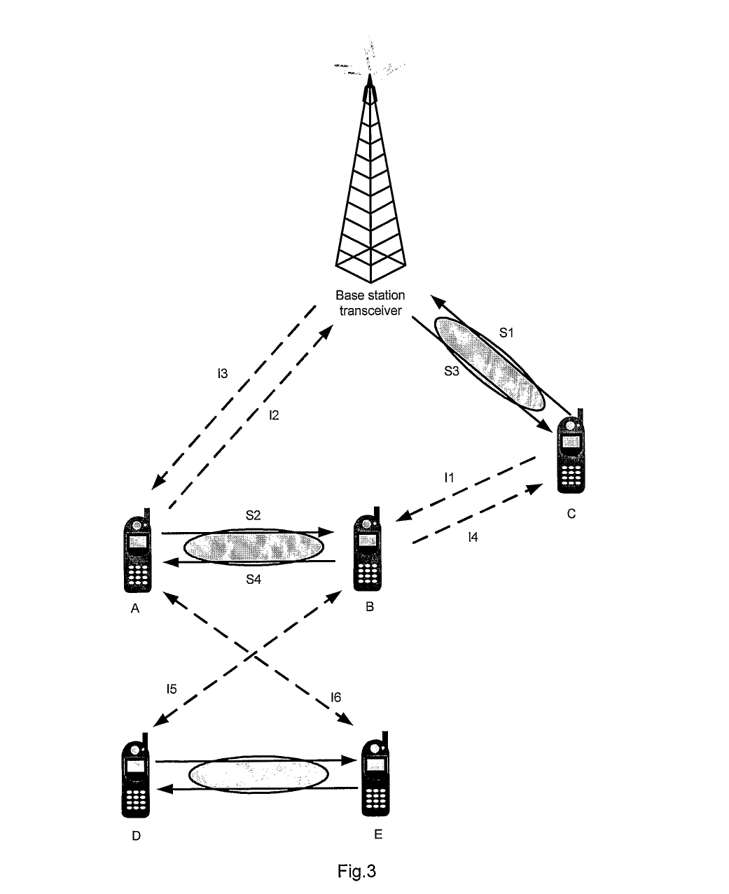

As described above, interfering signal I1, I4, I5 and I6 in FIG. 3 are all relevant with the position and distance of UEs, especially for I5 and I6 between two P2P link pairs, because the supported P2P radio transmission range is limited. When the distance between two P2P link pairs is far enough, interfering signal I5 and I6 could almost be ignored, even if they use the same radio resource. If we take the radio transmission scope formed by a close P2P link pair as a pseudo-cell, this is similar to the pico-cell or cell partition concepts.

In the present invention, the radio range formed by any P2P link pair is considered as a pseudo-cell, which fully exploits P2P communication's characteristics of having limited radio transmission range and transmission power. So far as the distance between each pseudo-cell exceeds a certain range, the same channel code can be assigned to the P2P link pair in a pseudo-cell and the P2P link pair in another pseudo-cell, to increase capacity for the communication system without causing the above interfering signal I5 and I6.

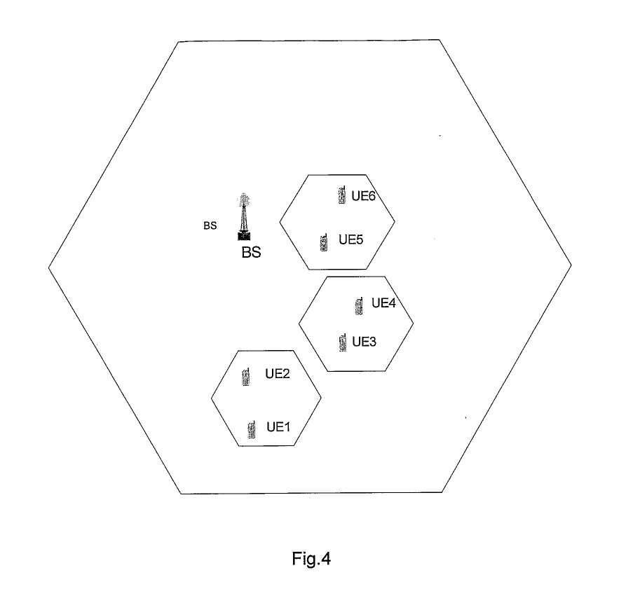

As shown in FIG. 4, the three P2P link pairs UE1 and UE2, UE3 and UE4, UE5 and UE6 form three pseudo-cells and distance between the three pseudo-cells is far enough, so the P2P communication between two UEs in a pseudo-cell won't be interfered by the ongoing P2P communications in other two pseudo-cells. Therefore, the same channel code can be assigned for the P2P links in the three pseudo-cells, and the two saved channel codes can be assigned to other UEs, so as to increase system capacity.

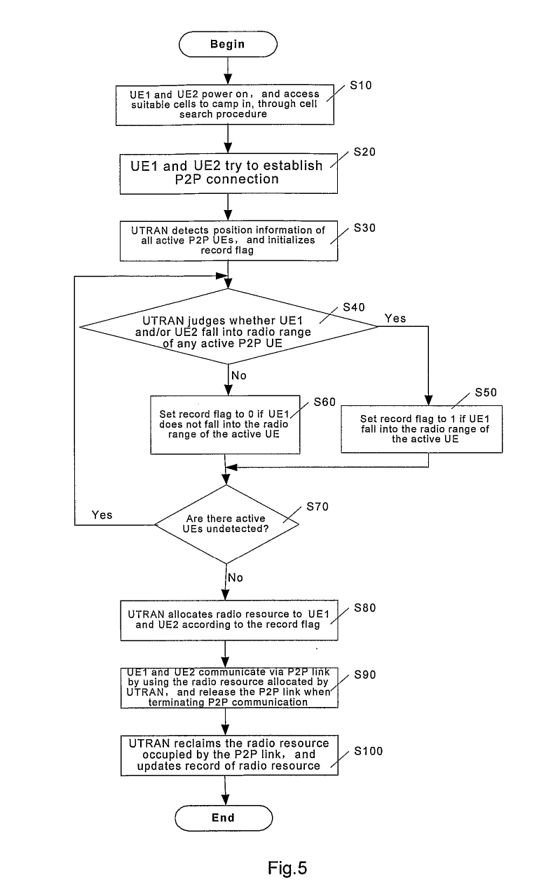

TD-SCDMA system will be exemplified to describe the method for increasing system capacity by reusing channel codes in the present invention, in conjunction with FIG. 5.

First, UE1 and UE2 search for suitable cells to camp through cell search procedure in conventional communication mode after powering on (step S10). Then, UE1 and UE2 attempt to establish P2P link between them by using the method and apparatus as disclosed in the above application with the application Serial NO. as 03119895.3 (step S20).

Afterwards, the UTRAN detects the position of all active P2P UEs in the cell, and initializes the record flag about the position relationship between each active UE and UE1 and/or UE2 (step S30). Herein, the UTRAN can obtain the position information through report messages sent by each active UE and UE1 and UE2 via uplink, or through GPS.

According to the detected position information, the UTRAN judges whether UE1 and/or UE2 fall within the radio range of an active P2P UE (step S40).

A description will be given below to how the UTRAN allocates radio resource according to the judgment result, by taking UE1 as an example. Steps to be executed by UE2 are the same as those by UE1.

If the judgment result shows UE1 falls within the radio range of an active UE, the record flag about the position relationship between the active UE and UE1 will be set as a certain value, for example 1 (step S50), for representing that UE1 and the active UE are allocated in the same timeslot and UE1 and the active UE should use different channel codes to enable P2P communication.

If the judgment result shows UE1 is beyond the radio range of an active UE, the record flag about the position relationship between the active UE and UE1 will be set as a certain value, for example 0 (step S60), for representing that UE1 and the active UE are allocated in the same timeslot and UE1 and the active UE can use the same channel code to enable P2P communication.

After executing the above detection, judgment, setting record flag steps for the active UE, the UTRAN detects whether UE1 and/or UE2 fall within the radio range of another active UE (step S70).

After executing the above steps from S40 to S60 for all active P2P UEs in the cell, the UTRAN allocates relevant radio resource for UE1 and UE2 according to the record flag about the position relationship between UE1 and UE2 and each active UE (step S80). That is, if the record flag for an active UE and UE1 or UE2 is 1 and the timeslot to be allocated for UE1 and UE2 is the same as the active UE according to the preliminary radio resource allocation scheme, the channel code to be allocated for UE1 and UE2 should be different from that for the active UE; if the record flags for the active UE and UE1 and UE2 are both 0, the same channel code can be allocated for UE1 and UE2 and the active UE. The radio resource allocated by the UTRAN not only includes information about the channel code, but also includes information about the timeslots and the scrambling codes used by the code group of the current cell.

Then, UE1 and UE2 communicate through P2P link using the radio resource allocated by the UTRAN. During P2P communication, the P2P link will always use the allocated channel code, unless the radio resource allocated for the P2P link changes, for instance, the timeslot allocated for the P2P link changes. When U1 and UE2 terminate P2P communication, UE1 and UE2 will release the P2P link (step S90). After UE1 and UE2 release the P2P link, the UTRAN reclaims the radio resource occupied by the P2P link and updates radio resource record (step S100).

The above method for increasing system capacity in P2P-enabled TD-SCDMA systems can be implemented in computer software, or hardware, or in combination of software and hardware.

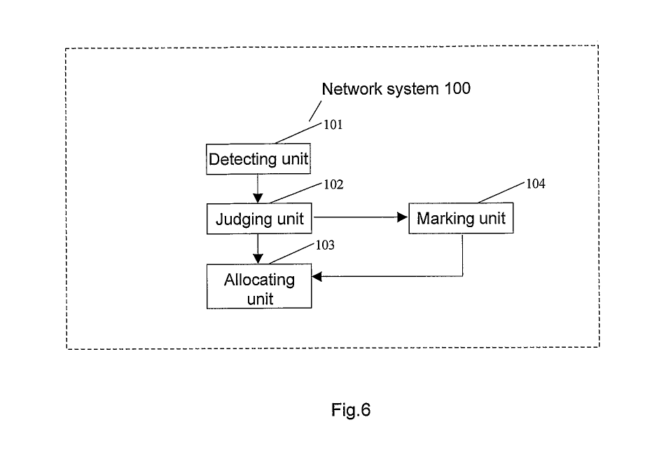

FIG. 6 is a block diagram illustrating the network system in an embodiment of the present invention for increasing system capacity in P2P-enabled TD-SCDMA systems, wherein the components same as in conventional network system are not given.

As FIG. 6 shows, network system 100 includes: a detecting unit 101, for detecting the position of active P2P UEs and the position of two UEs trying to establish P2P communication, wherein detecting unit 101 can obtain the position information from the report messages sent by said active P2P UE and UE1 and UE2 via uplink or through GPS; a judging unit 102, for judging whether UE1 and/or UE2 fall into the radio range of any active UE, according to the detected position information; when the UE1 and/or UE2 fall into the radio range of an active P2P UE, marking unit 104 sets the record flag of the active P2P UE as a predefined value, for example 1; allocating unit 103, for allocating relevant radio resource to UE1 and UE2 according to the record flag of the active P2P UE, so that UE1 and UE2 can perform P2P communication. That is, if UE1 and/or UE2 fall within the radio range of an active P2P UE, and UE1 or UE2 and the active P2P UE are allocated in the same timeslot, UE1 and UE2 will be allocated with channel codes different from the active P2P UE.

As described above, channel code reusing in this invention mainly takes advantages of cell partition concept (mini-cells) to increase CDMA communication system capacity. The communication method and apparatus in accordance with the present invention can implement reusing of channel codes through cell partition, even in the same cell. When allocating code resources, the UTRAN should take all active UEs in the whole cell into consideration, to minimize the interference between different pseudo-cells reusing the same channel code.

BENEFICIAL RESULTS OF THE INVENTION

As described above, with regard to the method and apparatus for increasing system capacity in P2P-enabled communication systems as provided in the present invention, the same channel code can be allocated for different pairs of UEs attempting to establish P2P communication in the pseudo-cells where different close P2P link pairs are camping. Therefore, the method and apparatus in the present invention can increase communication system capacity and different P2P link pairs won't produce interference to each other.

It is to be understood by those skilled in the art that the method and apparatus for increasing system capacity in P2P-enabled communication systems as disclosed in this invention is not limited herein for TD-SCDMA systems, but also applicable to be used for multi-hop communication and ad hoc communication in CDMA systems.

It is also to be understood by those skilled in the art that the method and apparatus for increasing system capacity in P2P-enabled communication systems as disclosed in this invention can be modified considerably without departing from the spirit and scope of the invention as defined by the appended claims.

What is claimed is:

1. A method for increasing P2P communication system capacity, performed by a network system, comprising:
(a) detecting the position of active P2P UEs in P2P communication mode and the position of two UEs trying to establish P2P communication;
(b) judging whether any of the two UEs falls into the radio range of any active UE except the two UEs, according to the detected position information;
(c) allocating corresponding radio resource to the two UEs so that the two UEs can perform P2P communication, according to the judgment result.

2. The method according to claim 1, wherein said radio resource at least includes information about timeslot and channel code.

3. The method according to claim 1, wherein step (c) includes:
(c1) allocating channel code different from that of said active P2P UE to the judged UE if the judged UE falls into said radio range.

4. The method according to claim 3, further comprising:
(d) determining whether the judged UE and said active P2P UE are assigned in the same timeslot;
(e) allocating channel code different from that of said active P2P UE to the judged UE if the judged UE and said active P2P UE are assigned in the same timeslot and the judged UE falls into said radio range.

5. The method according to claim 3, wherein step (c1) includes:
setting the record flag about the position relationship between the judged UE and said active P2P UE as a predefined value, if the judged UE falls into said radio range;
allocating channel code different from that of said active P2P UE to the judged UE, according to the record flag of said active P2P UE.

6. The method according to claim 1, wherein said position information is obtained from the report messages of said active P2P UE and said two UEs or through GPS in step (a).

7. The method according to claim 5, further comprising:
allocating channel code same with said active P2P UE to the judged UE if the judged UE doesn't fall into said radio range.

8. The method according to claim 7, further comprising:
reclaiming the radio resource occupied by the P2P communication when the P2P communication between said two UEs ends.

9. A network system, comprising:
a detecting unit, for detecting the position of active P2P UEs in P2P communication mode and the position of two UEs trying to establish P2P communication;
a judging unit, for judging whether any of the two UEs falls into the radio range of any active UE except the two UEs, according to the detected position information;
an allocating unit, for allocating corresponding radio resource to the two UEs so that the two UEs can perform P2P communication, according to the judgment result.

10. The network system according to claim 9, wherein said radio resource at least includes information about timeslot and channel code.

11. The network system according to claim 9, wherein said allocating unit allocates channel code different from that of said active P2P UE to the judged UE if the judged UE falls into said radio range.

12. The network system according to claim 11, wherein said allocating unit allocates channel code different from that of said active P2P UE to the judged UE if said judging unit determines that the judged UE and said active P2P UE are assigned in the same timeslot and the judged UE falls into said radio range.

13. The network system according to claim 11, further comprising:
a marking unit, for setting the record flag about the position relationship between the judged UE and said active P2P UE as a predefined value, if the judged UE falls into said radio range;
wherein said allocating unit allocates channel code different from said active P2P UE to the judged UE according to the record flag of said active P2P UE.
